(19) United States
(12) Patent Application Publication
(10) Pub. No.: US 2024/0375273 A1
(43) Pub. Date: Nov. 14, 2024

(54) Linear Transfer System for a Collaborative Robot

(71) Applicant: Thomson Industries, Inc., Marengo, IL (US)

(72) Inventors: James Kyle Thompson, Blacksburg, VA (US); Andrew Kenneth Skidmore, Radford, VA (US); Peter M. Castelli, Patchogue, NY (US)

(21) Appl. No.: 18/314,856

(22) Filed: May 10, 2023

(51) Int. Cl. B25J 9/16; B25J 5/02; B25J 13/08

(52) U.S. Cl. CPC B25J 9/1602; B25J 5/02; B25J 13/085

(57) ABSTRACT

A linear transfer system for a collaborative robot includes a linear bearing extending along a linear axis. A carriage on the linear bearing moves along the linear axis and supports a collaborative robot. One or more load cells are supported on either axial end of the carriage. A motor causes movement of the carriage along the linear axis under the control of a motor control circuit. The circuit receives input signals indicative of forces applied to the load cells. During a programming mode for the system, the circuit may generate control signals for the motor causing movement of the carriage along the linear axis corresponding to the forces applied to the load cells. During an operating mode of the system, the circuit may detect collisions by comparing the forces to a threshold and generating control signals to halt movement of the carriage if a predetermined condition is met.

### BACKGROUND OF THE INVENTION

### a. Field of the Invention

This disclosure relates to a linear transfer system for a collaborative robot, commonly referred to as a seventh axis system. In particular, the disclosure relates to a linear transfer system that facilitates programming of movements along the linear axis of the linear transfer system and collision sensing resulting from movement along the linear axis of the linear transfer system.

### b. Background Art

Collaborative robots, or cobots, are robots that are designed to operate in close proximity with humans in a shared, collaborative workspace and may directly interact with humans-unlike industrial robots which are generally isolated from contact with humans. Collaborative robots are generally configured to perform repetitive or menial operations while a human performs more complex and variable operations. Because collaborative robots share workspaces with humans, collaborative robots are generally designed to handle lighter loads (typically 25 kg or less) than industrial robots, engage in slower movements than industrial robots, and have a number of safety features (e.g., rounded edges, collision sensors) that are not required by industrial robots. A collaborative robot will typically include a base whose position is fixed and an arm extending from the base that is moved relative to the base by one or more motors. The arm has a plurality of joints that allows the arm to move along, and rotate about, a plurality of axes within a three-dimensional space. In many cases, it is desirable to extend the range of movement of a collaborative robot (and enlarge the three-dimensional operating space of the robot) by allowing movement of the base of the robot along an axis (e.g., for movement between work cells and machines). This axis is often referred to as the seventh axis and the systems that facilitate movement of the robot along the axis are often referred to as seventh axis systems, range extenders or, more generally, linear transfer systems.

Conventional linear transfer systems lack certain functionality that is often found in collaborative robots thereby limiting the functionality of the collaborative robot when combined with a linear transfer system. In particular, during a programming mode, an operator of a conventional collaborative robot is able to intuitively program a series of movements for a collaborative robot by releasing holding brakes in the robot that restrict movement at various joints of the robot, applying forces to the robot to move the robot between different positions and orientations, and recording information for each movement of the robot. No similar functionality is available in conventional linear transfer systems therefore preventing similar intuitive programmed movement of the robot along the seventh axis. Similarly, during operation a collaborative robot will detect collisions between the robot and the operator or another structure and, once a collision is detected, may halt or slow further movement of the robot or reverse movement of the robot A collision is generally detected using force sensors such as strain gauges mounted at various points on the robot arm or by monitoring increases in current required by motors moving segments of the arm when the arm comes into contact with the operator or an object. An operator has the ability to adjust settings in the robot to, for example, adjust the level of force that results in detection of a collision requiring a corrective action. Some conventional linear transfer systems do include mechanisms for detecting collisions as the robot moves along the seventh axis. These systems, however, generally rely solely on detecting increases in current in the motor driving the linear transfer system. These systems lack the ability to easily adjust the sensitivity of collision sensing in the linear transfer system and to optimize that sensing and allow operation of the system as a collaborative element similar to the robot.

The inventors herein have recognized a need for a linear transfer system for a collaborative robot that will minimize and/or eliminate one or more of the above-identified deficiencies.

### BRIEF SUMMARY OF THE INVENTION

This disclosure relates to a linear transfer system for a collaborative robot commonly referred to as a seventh axis system. In particular, the disclosure relates to a linear transfer system that facilitates programming of movements along the linear axis of the linear transfer system and collision sensing resulting from movements along the linear axis of the linear transfer system.

A linear transfer system for a collaborative robot in accordance with one embodiment includes a linear bearing extending along a linear axis. A carriage is supported on the linear bearing for movement along the linear axis and is configured to support a collaborative robot. The system further includes a motor configured to generate a motive force causing movement of the carriage along the linear axis, a load cell supported on the carriage proximate a first axial end of the carriage and a motor control circuit. The motor control circuit is configured to receive an input signal indicative of a force applied to the load cell and generate a control signal for the motor configured to cause a movement of the carriage along the linear axis. The movement corresponds to the force applied to the load cell.

A linear transfer system for a collaborative robot in accordance with another embodiment include a linear bearing extending along a linear axis. A carriage is supported on the linear bearing for movement along the linear axis and is configured to support a collaborative robot. The system further includes a motor configured to generate a motive force causing movement of the carriage along the linear axis, a load cell supported on the carriage proximate a first axial end of the carriage, and a motor control circuit. The motor control circuit is configured to receive an input signal indicative of a force applied to the load cell during movement of the carriage along the linear axis in a first axial direction, compare the force to a predetermined threshold force and generate a control signal to the motor configured to inhibit further movement of the carriage along the linear axis in the first axial direction if the force meets a predetermined condition relative to the predetermined threshold force.

A linear transfer system for a collaborative robot in accordance with another embodiment includes a linear bearing extending along a linear axis. A carriage is supported on the linear bearing for movement along the linear axis and is configured to support a collaborative robot. The system further includes a motor configured to generate a motive force causing movement of the carriage along the linear axis and a motor control circuit. The motor control circuit is configured to establish a motor position error threshold, compare a difference between an actual motor position and a commanded motor position to the motor position error threshold and generate a control signal to the motor configured to inhibit further movement of the carriage along the linear axis if the difference between the measured motor position and the commanded motor position meets a predetermined condition relative to the motor position error threshold.

A linear transfer system for a collaborative robot in accordance with the present teachings is advantageous relative to conventional linear transfer systems. In certain embodiments, the linear transfer system enables an operator to intuitively program movements of the linear transfer system in a manner similar to programming a collaborative robot, but with assistance from a motor of the linear transfer system. In other embodiments, the linear transfer system is able to detect collisions resulting from movement of the linear transfer system while also allowing an operator to adjust the sensitivity of the collision sensing system and achieving greater accuracy in collision sensing. In other embodiments, the linear transfer system is able to accomplish both intuitive programming of movement of the system and improved collision sensing using the same operative components.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic and perspective view of one embodiment of a linear transfer system for a collaborative robot in accordance with the teachings disclosed herein.

FIG. 2 is a transparent perspective view a portion of a linear slide assembly of the linear transfer system of FIG. 1.

FIG. 3 is cross-sectional view of another portion of a linear slide assembly of the linear transfer system of FIG. 1.

FIG. 4 is a transparent perspective view a portion of a drive mechanism for the linear transfer system of FIG. 1.

FIG. 5 is a perspective view of a portion of a carriage of the linear slide assembly of the linear transfer system of FIG. 1.

FIG. 6 is a diagrammatic view of a motor control circuit of the linear transfer system of FIG. 1.

FIG. 7 is a flowchart diagram illustrating one embodiment of a method for programming movements of the linear transfer system of FIG. 1.

FIG. 8 is a flowchart diagram illustrating one embodiment of a method for establishing thresholds for sensing collisions resulting from movement of the linear transfer system of FIG. 1.

FIG. 9 is a flowchart diagram illustrating one embodiment of a method for detecting collisions resulting from movement of the linear transfer system of FIG. 1.

### DETAILED DESCRIPTION OF EMBODIMENTS OF THE INVENTION

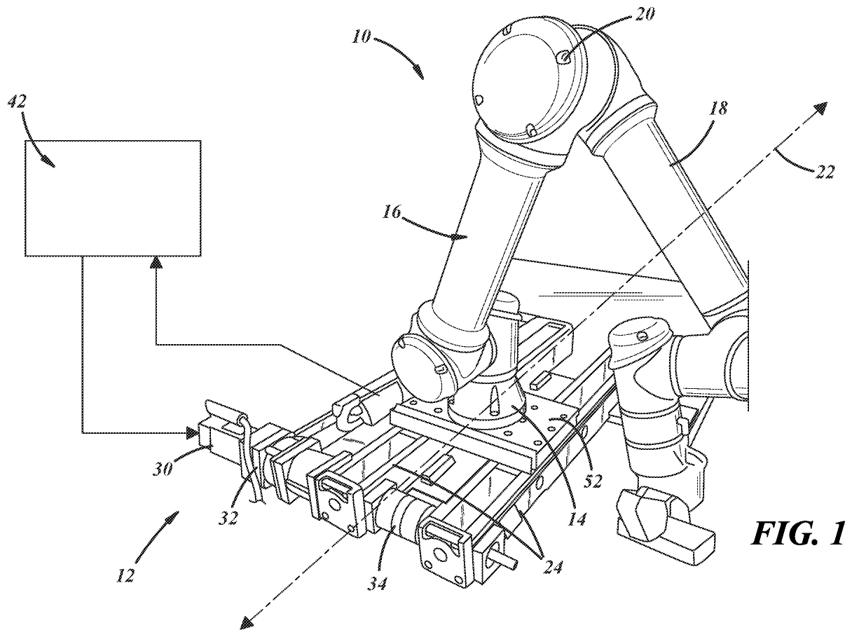

Referring now to the drawings wherein like reference numerals are used to identify identical components in the various views, FIG. 1 a collaborative robot 10, or cobot, mounted on a linear transfer system 12. Robot 10 may be used to perform a variety of tasks in collaboration with one or more humans within a three-dimensional operating space. In certain embodiments, robot 10 may comprise a collaborative robot offered for sale by Universal Robots A/S. It should be understood, however, that robot 10 may comprise a collaborative robot offered by a different seller of collaborative robots in other embodiments. Robot 10 includes a base 14 and an arm 16 extending from base 14. The arm 16 includes a plurality of individual segments 18 that are coupled to base 14 and other segments 18 by joints 20 that permit segments 18 to move relative to base 14 and other segments 18 along and about various axes in the three-dimensional operating space. Robot 10 may further include motors (not shown) for causing movement of individual segments 18 of arm 16 and brakes (not shown) for braking movement of individual segments 18 of arm 16. Robot 10 may further include force sensors (not shown), such as strain gauges, for detecting collisions between robot 10 and humans or other objects within the operating space. Finally, robot 10 may include elements for programming and controlling the operation of robot 10 such as a controller and a user interface described in greater detail hereinbelow.

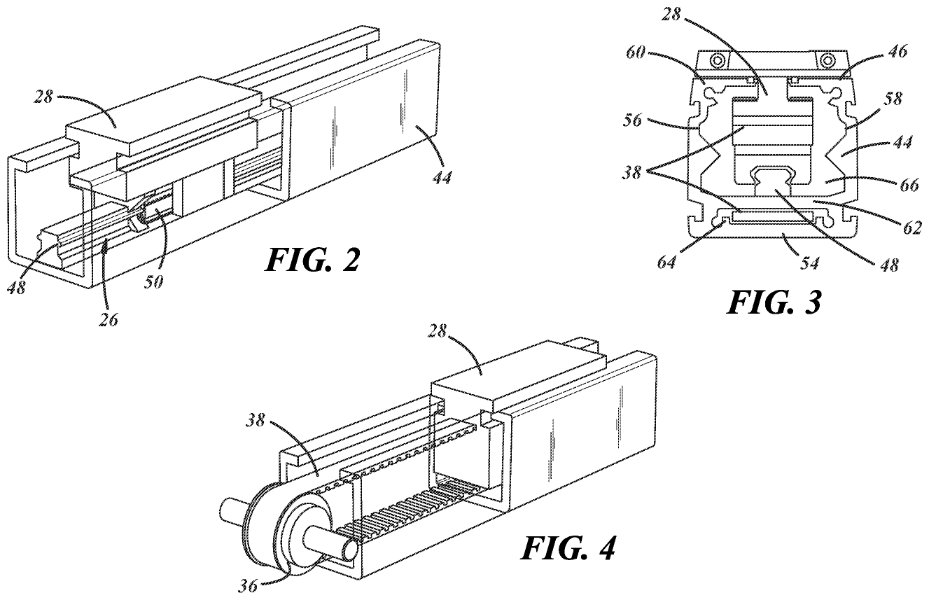

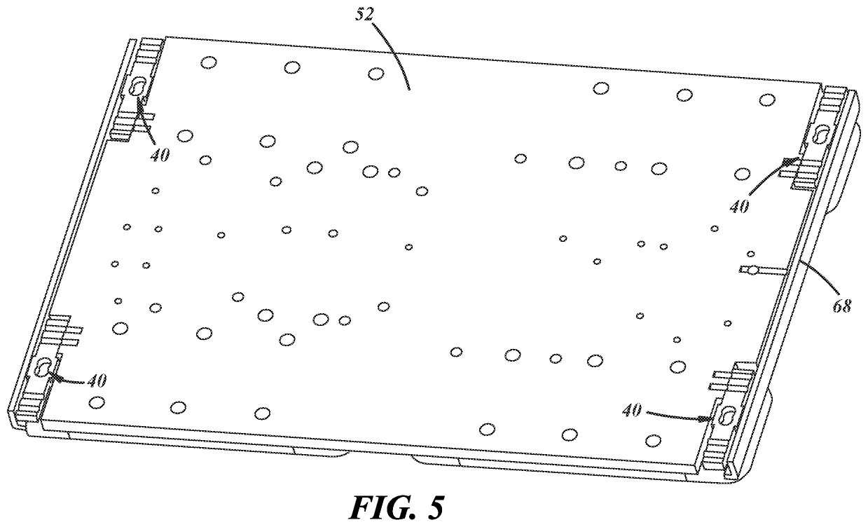

Linear transfer system 12 is provided to extend the reach of robot 10 and the three-dimensional operating space for robot 10 by moving robot 10 along a linear axis 22 (commonly referred to as a seventh axis). Although axis 22 is substantially horizontal in the illustrated embodiment, it should be understood that the orientation of axis 22 may vary and may, for example, be vertical or simply inclined. System 12 may include one or more linear slide assemblies 24 each of which may include, with reference to FIGS. 2-3, a linear bearing 26 and a carriage 28 among other components. Referring again to FIG. 1, system 12 may further include a motor 30 and means, such as a gearhead 32, a coupling 34 and, with reference to FIG. 4, pulleys 36 and belts 38, for translating a rotational force output by motor 30 to a linear force for moving the carriage 28 along the linear bearings 26 and axis 22. Referring to FIG. 5, system 12 may further include means, such as load cells 40, for sensing a mechanical force applied to the carriage 28. Referring again to FIG. 1, system 12 further include, means, such as a motor control circuit 42 for controlling motor 30.

Linear slide assemblies 24 define the linear axis 22 along which robot 10 moves and provide a framework for moving robot 10 along axis 22. Assemblies 24 may comprise any of a number of different linear slide assemblies offered for sale by the Applicant, Thomson Industries, Inc. In the illustrated embodiment, a pair of parallel linear slide assemblies 24 are used to support and move robot 10. It should be understood, however, that the number of linear slide assemblies 24 may vary and that, for example, a single linear slide assembly 24 may be sufficient for movement of robot 10 along axis 22 depending on the configuration of robot 10 and the nature of the tasks performed by robot 10. Referring again to FIGS. 2-3, in one embodiment each linear slide assembly 24 may include linear bearing 26, carriage 28, a housing 44, and a cover 46 among other components. It should be understood, however, that the configuration of linear slide assembly 24 may vary.

Linear bearing 26 is provided to support carriage 28 for movement along axis 22. Bearing 26 may include a rail 48 and a bearing 50. Rail 48 supports the load and moment load of carriage 28 and robot 10. Rail 48 has a profile configured to support carriage 28 and to allow movement of carriage 28 along axis 22 while also preventing movement of carriage 28 along other axes in the operating space for robot 10 and system 12 (e.g., a dovetail configuration). Bearing 50 is provided to reduce friction between rail 48 and carriage 28 as carriage 28 moves along rail 48. Bearing 50 may, for example, include a plurality of caged balls or rollers disposed between the rail 48 (inner race) and carriage 28 (outer race). It should be understood that the configuration of linear bearing 26 may vary and that linear bearing 26 may, for example, comprise a round rail, cam roller or other type of low-friction linear bearing.

Carriage 28 is configured to support robot 10. Carriage 28 may be supported on linear bearing 26 for movement along linear axis 22. Referring to FIG. 5, because multiple linear slide assemblies 24 are used in the illustrated embodiment, the carriage of linear transfer system 12 may further include a mounting plate 52 or similar member joining the individual carriages 28 in linear slide assemblies 24 to form a single carriage configured to support robot 10 for movement along the linear bearings 26 of linear slide assemblies 24 and along axis 22.

Referring again to FIGS. 2-3, housing 44 supports and orients other components of assembly 24 and protects certain components from foreign elements and objects. Housing 44 may comprise a longitudinally extending, tubular extrusion made from aluminum or other metals that is sealed at either longitudinal end by end caps (not shown). Referring to FIG. 3, although the shape of housing 44 may vary, in the illustrated embodiment, housing 44 is rectilinear in shape defining a bottom wall 54, opposed side walls 56, 58 extending vertically from the bottom wall 54, a top wall 60 opposite the bottom wall 54 and defining an opening through which carriage 28 extends, and a cross-wall 62 disposed between the bottom and top walls 54, 60 and extending between the two side walls 56, 58 that divides the interior of housing 44 into a lower channel 64 configured to receive a portion of belt 38 and an upper channel 66 configured to receive linear bearing 26 and a portion of carriage 28.

Cover 46 at least partially closes the upper channel 66 in housing 44. Cover 46 may comprise a metal strip secured to housing 44 by magnets (not shown) and to end caps (not shown) at either of housing 44 by spring-loaded anchors (not shown) that lifts from housing 44 ahead of carriage 28 and recloses behind carriage 28 as carriage 28 moves along linear bearing 26 and axis 22.

Referring again to FIG. 1, motor 30 is provided to generate a motive force causing movement of carriage 28 along linear bearing 26 and linear axis 22. Motor 30 may comprise an electric servo motor offered for sale by Kollmorgen Corporation. Motor 20 includes an encoder, potentiometers or similar feedback sensors configured to generate an indication of the actual position, and change in position, of an output shaft of motor 30 for a purpose described hereinbelow.

Gearhead 32, coupling 34, pulleys 36 and belts 38 provide a means for translating a rotational force generated by motor 30 into a linear force for moving carriage 28. Gearhead 32 is provided to adjust the rotational speed and torque output by motor 30 for subsequent use in applying a linear force to carriage 28 and for inertia matching between motor 30 and the load driven by motor 30 including robot 10 and carriage 28. Gearhead 32 may comprise an in-line planetary gearhead offered for sale by Boston Gear LLC under the name “Micron True Planetary.” Coupling 34 is disposed between linear slide assemblies 24 and connects a drive shaft of gearhead 32 extending through one linear slide assembly 24 proximate motor 32 and gearhead 32 with a driven shaft extending into the other linear slide assembly 24 distant from motor 30 and gearhead 32 to transmit torque to the driven shaft. Coupling 34 may comprise a beam coupling offered for sale by Huco Engineering Industries, Ltd. Referring again to FIG. 4, pulleys 36 support and drive belts 38. Pulleys 36 may be disposed at each axial end of each linear slide assembly 24. The pulleys 36 at one axial end of each linear slide assembly 24 are supported on the drive shaft of gearhead 32 and the driven shaft that is coupled to the drive shaft through coupling 34 for rotation with the drive shaft and driven shaft, respectively. The pulleys 36 at the other axial end of each linear slide assembly 24 may be supported for rotation about stationary shafts by bearings (not shown). Each pulley 36 may comprise a toothed pulley. Belts 38 couple each axial end of carriage 28 to the pulleys 36 at each axial end of linear slide assembly 24. Belts 38 may comprise toothed belts having a first end configured for engagement with a corresponding pulley 36 and a second end fixedly attached to one axial end of carriage 28. A rotational torque generated by motor 30 causes corresponding rotation of pulleys 36 at one end of linear slide assembly 24 and linear movement of belts 38 and carriage 28. It should be understood that the illustrated embodiment of linear transfer system 12 shows only one potential embodiment of means for translating a rotational force generated by motor 30 into a linear force for moving carriage 28. In an alternative embodiment, the means may include lead screws or ball screws driven by motor 30 and corresponding lead nuts or ball nuts coupled to carriage 28 and supported on lead screws or ball screws for linear movement along the screws in response to rotation of the screws. In yet another embodiment, means for translating a rotational force generated by motor 30 into a linear force for moving carriage 28 may include a pinion driven by motor 30 that moves a rack coupled to carriage 28.

Referring again to FIG. 5, load cells 40 provide means for sensing a mechanical force applied to the carriage 28. Load cells 40 generate electrical signals indicative of a mechanical force applied to the load cell 40 and, consequently, carriage 28. Load cells 40 may be mounted on each axial end of carriage 28. In the illustrated embodiment, load cells 40 are mounted to each axial end of mounting plate 52 supported on the carriage 28 of each linear bearing 26. In one embodiment, two load cells 40 are mounted on each axial end of plate 52 and spaced from one another (e.g., at each corner of plate 52). The load cells 40 on either axial end of carriage 28 and plate 52 may be mechanically coupled through a connecting bar 68 extending between the load cells such that a force applied anywhere along the connecting bar 68 generates corresponding forces on the load cells 40. In this manner, a larger sensing area is formed on carriage 28 that can identify forces (and collisions) without direct contact with load cells 40.

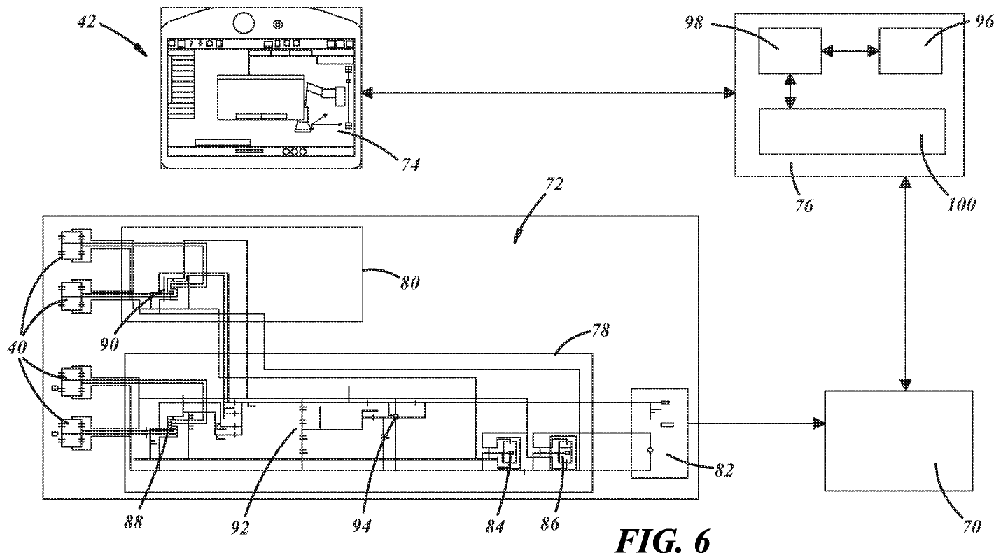

Motor control circuit 42 provides a means for controlling motor 30 and, therefore, movement of carriage 28 and robot 10 along linear bearing 26 and axis 22. Referring now to FIG. 6, motor control circuit 42 may include a motor drive 70, a force sensing circuit 72, an interface 74 and a controller 76.

Motor drive 70 provides current to motor 30 to generate rotational movement of motor 30 and generate a motive force. Drive 70 directs an appropriate amount of current to motor 30 from a power source (not shown) such as a direct current (DC) battery responsive to signals from force sensing circuit 72 and controller 76. Drive 70 may also be responsive to limit switches (not shown) at either end of each linear slide assembly 24 to terminate delivery of current to motor 30 and movement of carriage 28 and robot 10 when carriage 28 and robot 10 reach a maximum axial stroke length. Drive 70 continuously compares the commanded position for motor 30 with the actual position of motor 30 as indicated by the encoder of motor 30 or a similar position sensor of motor 30 and adjusts current flows to motor 30 to adjust the position of motor 30 and minimize differences between the commanded position and the actual position of motor 30. Drive 70 may comprise the motor drive offered for sale by Kollmorgen Corporation under the trademark “AKD2G.” Drive 70 may communicate with controller 76 over a communications bus (not shown) operating in accordance with any of a variety of conventional communication protocols including modbus, CANopen or EtherCAT.

Force sensing circuit 72 is provided to process signals generated by load cells 40 and transfer information from those signals to motor drive 70. Elements of circuit 72 may be located on two printed circuit boards—a primary or main circuit board 78 and a secondary or satellite circuit board 80. In the illustrated embodiment, each circuit board 78, 80 is configured to receive input signals generated by a pair of load cells 40. For example, board 78 may receive signals from load cells 40 disposed on one axial side of carriage 28 (or plate 52) while board 80 receives signals from load cells 40 disposed on the other axial side of carriage 28 (or plate 52). Board 78 is further configured to receive power from an external power supply 82 and transfer power to board 80 and is also configured to output signals to drive 70 indicative of forces measured by load cells 40. Circuit 72 may include voltage regulators 84, 86, operational amplifiers 88, 90, a trimmer potentiometer 92, a differential amplifier 94.

Voltage regulators 84, 86 are provided to regulate voltage from the external power supply (not shown) to maintain a constant voltage despite changes to the input voltage received from the external power supply. Voltage regulators 84, 86 are configured to maintain a voltage (e.g., five (5) volts) for use by amplifiers, 88, 90 and trimmer potentiometer 88.

Amplifiers 88, 90 are disposed on each board 78, 80, respectively, and are provided to amplify the signals from load cells 40 on either axial side of carriage 28. Amplifiers 88, 90 also add an offset voltage (e.g., five (5) volts).

Trimmer potentiometer 92 (or trim pot) is provided to calibrate the signals output by amplifiers 88, 90. Trim pot 92 accounts for the starting offset of load cells 40 so that the final signal coming from board 78 is near the middle of the range read by the analog input to drive 70. Trip 92 sets a high voltage from which the averaged readings of load cells 40 are subtracted.

Differential amplifier 92 is provided to average the signals from all of the load cells 40 on each side axis side of carriage 28. In particular, amplifier 92 averages signals output by amplifiers 88, 90 and subtracts this average from the voltage output by trimmer potentiometer 92.

Interface 74 comprises a human machine interface (HMI) allowing a user to program and control robot 10 and linear transfer system 12. Interface 74 may be configured to receive inputs from a user including commands for movement of robot 10 and linear transfer system 12 and thresholds used for collision sensing and other functions. Interface 74 may be configured to generate outputs to the user including information regarding movements of robot 10 and linear transfer system 12, the status of components of robot 10 and linear transfer system 12, and notices regarding actual or potential collisions between robot 10 and linear transfer system 12 with users or other objects. In some embodiments, interface 74 may comprise the interface marketed under the name “Teach Pendant” by Universal Robots A/S. In other embodiments in which robots offered by other sellers of collaborative robots are employed, interface 74 may comprise an interface provided by the particular seller. Interface 74 may include one or more conventional input, output, or input/output elements including, for example, a touch screen display, keys, buttons, etc.

Controller 76 is provided to control motor drive 70 to control motor 30 and movement of carriage 28 of linear transfer system 12. In certain embodiments, controller 76 may also control movement of robot 10. Controller 76 may comprise a programmable microprocessor or microcontroller or may comprise an application specific integrated circuit (ASIC). In accordance with the present teachings, controller 76 may be configured with appropriate programming instructions (i.e., software or a computer program) to implement certain steps in methods for programming movements of linear transfer system 12, establishing thresholds for sensing collisions resulting from movement of linear transfer system 12, and detecting collisions resulting from movement of linear transfer system 12 as described in greater detail hereinbelow. Controller 76 may include a memory 96 and a central processing unit (CPU) 98. Controller 72 may also include an input/output (I/O) interface 100 including a plurality of input/output pins or terminals through which controller 76 may receive a plurality of input signals and transmit a plurality of output signals. The input signals may include signals received from drive 70 and interface 74 and the output signals may include signals transmitted to drive 70 and interface 74. In the illustrated embodiment, a single controller 76 is shown. It should be understood, however, that the functionality of controller 76 described herein may be divided among multiple sub-controllers.

Linear transfer system 12 may have several different modes of operation. During a programing mode prior to regular operation of robot 10 and linear transfer system 12, motor control circuit 42 may allow a user to program movements of linear transfer system 12 and to establish thresholds for sensing collisions resulting from movement of linear transfer system 12. During a subsequent operating mode of robot 10 and linear transfer system 12, motor control circuit 42 is configured to detect collisions resulting from movement of robot 10 and linear transfer system 12 in addition to controlling the movement of robot 10 and linear transfer 12.

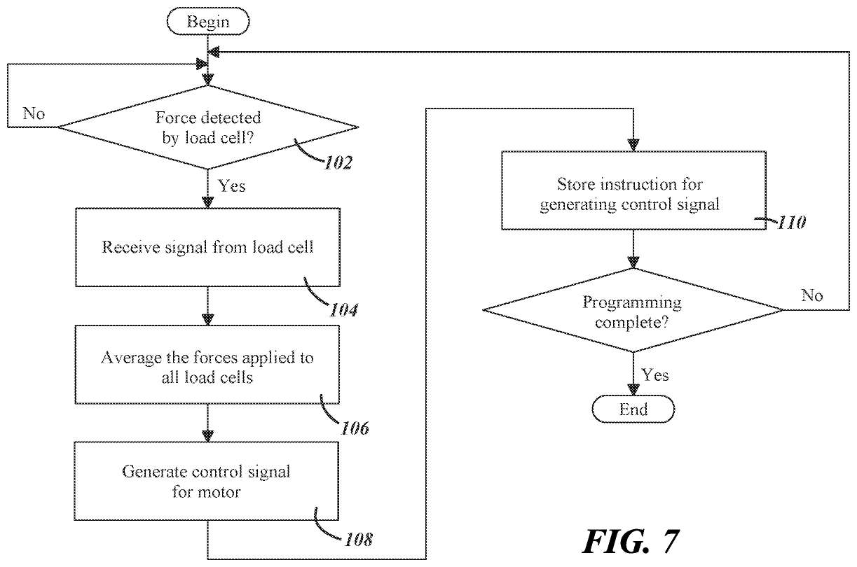

Referring now to FIG. 7, a method for programming movements of linear transfer system 12 may begin with the step 102 of a user applying a force, directly or indirectly, to one or more of load cells 40. Any load cell 40 to which a force is applied will generate a signal indicative of the force applied to that load cell 40. In step 104, motor control circuit 42 will receive one or more input signals from load cells 40. As discussed above, the input signals will be received and processed by force sensing circuit 72. In step 106, force sensing circuit 72 of motor control circuit 42 will average the forces applied to the load cells 40 to obtain an average force applied to carriage 28 of linear transfer system 12. If a force is applied to only one load cell 40, the average force will be equal to the force applied to that load cell 40. If forces are applied to more than one load cell 40—either on the same axial side of carriage 28 or on opposite axial sides of carriage 28—the average force will be equal to the forces applies to multiple load cells 40 taking into account both the amount of each force and direction of each force. For example, in the embodiment in FIGS. 5-6 in which two load cells 40 are disposed on each axial side of carriage 28, the forces applied to the two load cells 40 on one axial side and acting in one axial direction will be summed by amplifier 88 and the forces applied to the two load cells 40 on the opposite axial side and acting in the opposite axial direction will be summed by amplifier 90. Thereafter, the two summed values will be average by differential amplifier 94 and because the forces on the load cells 40 on either axial side of carriage 28 are acting in opposite directions, the value from one side will be subtracted from the value for the other side. Amplifier 94 will output a signal having a voltage level indicative of the amount of the total force and a positive or negative voltage indicative of the direction of the total force.

The method may continue with the step 108 of generating a control signal for motor 30 responsive to the average force (i.e., the force applied to one load cell 40 or the average of forces applied to multiple load cells 40) to cause a movement of carriage 28 along linear bearing 26 in either axial direction along axis 22. The movement will correspond to the average force applied to the load cells 40. In particular, speed of the movement will correspond to the average force such that the greater the force applied to load cells 40 (in one direction), the faster the carriage 28 and robot 10 will move along linear bearing 26 and axis 22 in the commanded direction. As discussed hereinabove, force sensing circuit 72 will output a signal to motor drive 70 indicative of the average force applied to load cells 40. Drive 70 will generate the control signal for motor 30 in response to this signal causing motor 30 to output a motive force and thereby causing movement of carriage 28 and robot 10 along linear bearing 26 and axis 22.

The method may continue with the step 110 of storing an instruction for generating the control signal on a future occasion. As movement of motor 30 occurs in response to the control signal, the encoder in motor 30 will generate signals indicative of the rotational position, and change in rotational position, of motor 30 and, therefore, the linear position, and change in linear position, of carriage 28 and robot 10. This information may be communicated by drive 70 to controller 76 over the communications bus between drive 70 and controller 76. Controller 76 may formulate and store an instruction in memory 96 responsive to this information that is configured to cause drive 70 to generate a control signal at a future time resulting in similar movement of motor 30, carriage 28 and robot 10. It should be understood that controller 76 may formulate and store the instruction immediately upon receipt of the information or may alternatively store the information and formulate and store the instruction at a later time.

As indicated in FIG. 7, the steps 102, 104, 106, 108, 110 may be performed a plurality of times. It should be understood that each sequence of steps 102, 104, 106, 108, 110 may begin with application of forces to the same load cell 40 or combination of load cells 40 or may involve application of forces to different load cells 40 or combinations of load cells 40. In this manner, a user may program a series of movements of linear transfer system 12. Currently, movements of robot 10 may be programmed by a human by releasing the holding brakes on joints 20 of robot 10, applying forces to robot 10 to move segments 18 of robot 10 and recording information relating to the movements to allow repetition of the movement. As noted above, robot 10 may comprise a robot offered for sale by Universal Robots A/S in certain embodiments (it should be understood, however, that robot 10 may comprise a collaborative robot offered by a different seller of collaborative robots in other embodiments). Universal Robots A/S refers to this programming method as “Freedrive” because the programmer may move the robot 10 without resistance from the brakes that normally lock joints 20. This programming mode, however, still requires the operator to overcome opposing forces resulting from the weight of robot 10 and individual segments 18 of robot 10 and friction at joints 20 between segments 18 of robot 10. Conventional linear transfer systems lack similar functionality. In particular, while it is possible to program movements of a linear transfer system through a user interface such as interface 74, the programmer cannot move carriage 28 and robot 10 between positions along axis 22 through a direct application of force on the carriage 28. In accordance with one aspect of the teachings herein, a system and method for programming linear transfer system 12 is provided that allows the user to move carriage 28 and robot 10 between positions along axis 22 through direct application of force on the carriage 28 and, in particular, on load cells 40 mounted on carriage 28. Moreover, in contrast to the “Freedrive” system described above that may be used to program movements of robot 10, the system and method described herein for moving linear transfer system 12 in response to application of user applied forces assists the user through generation of motive forces from motor 30 thereby eliminating the need for the user to apply forces to overcome the weight of the robot 10 and carriage 28 and friction forces between the carriage 28 and linear bearing 26. As a result, the user can exercise precise control in programming movements of linear transfer system 12 and enable use of system 12 in applications where automation has been difficult to achieve.

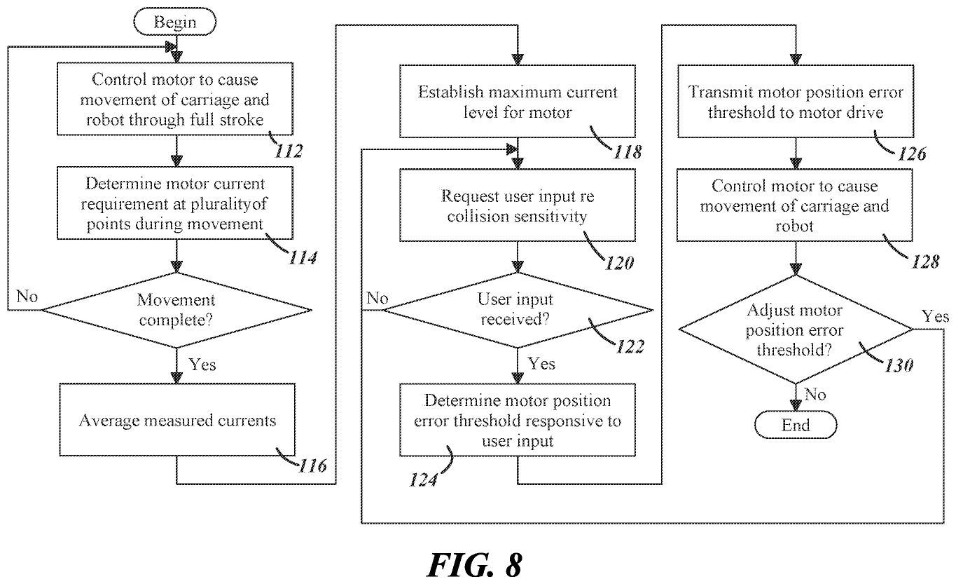

As noted above, motor control circuit 42 may also be configured to allow a user to establish thresholds for sensing collisions resulting from movement of linear transfer system 12 during a programming mode of operation. Referring now to FIG. 8, a method for establishing thresholds for sensing collisions resulting from movement of linear transfer system 12 may begin with the step 112 of controlling motor 30 to move carriage 28 through a full stroke along liner bearing 26 and axis 22 (i.e., from one axial end of linear bearing 26 to an opposite axial end of linear bearing 26). Circuit 42 may generate a plurality of control signals for motor 30 to cause motor 30 to generate a motive force and move carriage 28 and robot 10 along linear bearing 26 and axis 22. The method may continue with the step 114 of determining an amount of current required by motor 30 at each of a plurality of different points as carriage 28 moves along the length of linear bearing 26 and axis 22. These different points may be different axial positions along axis 22 and may be evenly or unevenly spaced. Alternatively, these different points may be based on different times as carriage 28 moves along axis 22 and again may be evenly or unevenly spaced. Drive 70 may provide information regarding the current required by motor 30 to controller 76 over the communication bus between drive 70 and controller 76 at each of the different points.

Once carriage 28 has been moved through the full stroke, the method may continue with the step 116 of averaging the amounts of current required by the motor 30 at each of the plurality of different points to obtain an average current. In particular, controller 76 may calculate the average current required by motor 30 along the full stroke of movement. The method may then continue with the step 118 of establishing a maximum current level for motor 30 responsive to the average current. Controller 76 may, for example establish the maximum current level by multiplying the average current by a predetermined factor (e.g., between 1.05 and 1.5). Controller 76 may then communicate the maximum current to drive 70 over the communications bus between drive 70 and controller 76. Thereafter, the maximum current value will limit the amount of current that may be provided to motor 30 by drive 70.

Once the maximum current value is established, the method may proceed with several steps 120, 122, 124, 126 to establish a motor position error threshold for use in detecting collisions between linear transfer system 12 and users or nearby objects during operation of linear transfer system 12. Although some conventional linear transfer systems identify collisions by detecting increases in motor current, the inventors have, in accordance with one aspect of the teachings disclosed herein, determined that increases in motor position error—the difference between a commanded position for motor 30 and the actual position motor 30—is a faster and more effective approach for identifying collisions. In particular, when a collision occurs in a conventional linear transfer system, the system will increase the amount of current provided until the current reaches an established maximum current level established by the system. As a result, the linear transfer system will attempt to “push through” the collision initially. By detecting collisions using increases in the motor position error, however, collisions can be detected and addressed more quickly than relying on motor current levels alone.

In step 120, controller 76 may request that a user input an indication of collision sensitivity or the amount of force generated in any collision that is required to indicate a collision. Controller 76 may generate a request for the user input through interface 74. In step 122, controller 76 may receive a user input through interface 74 through, for example use of a touch screen display or other input mechanism. In steps 124 and 126, controller 76 determines a motor position error threshold responsive to the user input and transmits the threshold to drive 70 over the communications bus between drive 70 and controller 76. The initial motor position error threshold in drive 70 may have an initial or default value that is preset based on various factors including, for example, the size of robot 10. The motor position error threshold may be expressed in various units of distance including linear (e.g., millimeters) and angular (e.g., degrees) units of measurement.

In some embodiments, users may perform additional steps 128, 130 to calibrate the motor position error threshold as part of establishing the motor position error threshold. For example, in step 128, a user may initiate a movement of linear transfer system to bring linear transfer system 12 into contact with the user or an object. In step 130, the user may evaluate whether linear transfer system 12 detected the collision or whether the motor position error threshold determined in step 124 requires adjustment. If adjustment is required, steps 120, 122, 124, 126 may be repeated to adjust the collision sensitivity and the corresponding motor position error threshold. Calibration steps 128, 130 may also be repeated as needed until a desired collision sensitivity and motor position error threshold are established.

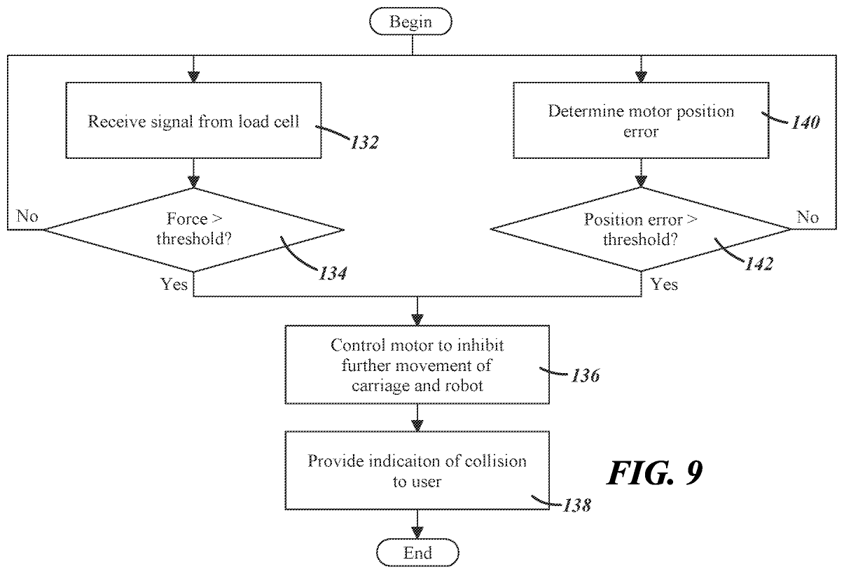

Once various actions associated with programming linear transfer system 12 for operation are complete, the system 12 may shift from the programming mode to an operating mode in which the linear transfer system 12 proceeds through a series of movements programmed during the programming mode. Referring now to FIG. 9, one embodiment of a method for detecting collisions resulting from movement of linear transfer system 12 during the operating mode will be described. In accordance with one aspect of the teachings disclosed herein, the method may employ multiple different tests to detect collisions.

In some embodiments, the method may include several steps intended to detect collisions using load cells 40. In this manner, the system and method disclosed herein have the advantage of using the same structure for both programming movements of linear transfer system 12 during the programming mode for system 12 (see, e.g., FIGS. 7-8) and for detecting collisions between system 12 and users or objects during the operating mode for system 12. The method may begin with the step 132 in which motor control circuit 42 receives one of more input signals indicative of forces applied to one or more of load cells 40 during movement of carriage 28 along linear bearing 26 and axis 22. As discussed hereinabove, these signals are received by force sensing circuit 72. Where signals are received from multiple load cells 40 the forces indicated by the signals may be averaged by circuit 72 as discussed hereinabove. A signal indicative of the total force applied to load cells 40 is output from circuit 72 to motor drive 70 and may also be transmitted to controller 76 over the communications bus between drive 70 and controller 76.

The method may continue with the step 134 in which drive 70 compares the total force applied to the load cells 40 to a predetermined threshold force. The predetermined threshold force may be stored in a memory of drive 70 and may be a value that is sufficiently high to present false positives when detecting collisions, but sufficient low to allow for detect of virtually all actual collisions. If the force applied to load cells 40 meets a predetermined condition relative to the predetermined threshold force (e.g., is greater than the predetermined threshold force), the method may continue with the step 136 of generating a control signal from drive 70 to motor 30 that is configured to inhibit further movement of carriage 28 along linear bearing 26 and axis 22 in the axial direction in which carriage 28 was moving when motor control circuit 42 received the signals from load cells 40. The control signal may further be configured to cause movement of carriage 28 along linear bearing 26 and axis 22 in an axial direction opposite to the axial direction in which carriage 28 was moving when motor control circuit 42 received the signals from load cells 40. The control signal may therefore cause motor 30 to terminate delivery of any motive force or may cause motor 30 generate a motive force causing carriage 28 and robot 10 to move in the opposite axial direction. Drive 70 may also transmit a signal to controller 76 to alert controller 76 to the collision and thereby allow controller 76 to generate corresponding control signals to terminate movement of robot 10. Finally, in step 138 controller 76 may transmit an indication of a collision to a user through, e.g., interface 74 or another audio, visual or haptic feedback system. A user of robot 10 and system 12 may be required to perform certain actions before movement can resume.

Steps 132, 134, 136 and 138 have been described above in connection with collisions detected as a result of movement of linear transfer system 12 and robot 10 along axis 22. In accordance with another aspect of the teachings disclosed herein, however, substantially the same steps can be used by an operator to instruct the linear transfer system 12 to remain in a stationary position along axis 22 or to prevent movement of system 12 in one axial direction along axis 22. In particular, during the operating mode an operator can apply a force to one or more load cells 40 on one axial side of carriage 28 while linear transfer system 12 is stationary to simulate a collision ordinarily resulting from movement of system 12 along axis 22 in one axial direction. Steps 132, 134, 136 and 138 may proceed in the same manner such that linear transfer system 12 remains stationary or moves in the opposite axial direction.

In certain embodiments, a method for detecting collisions during operation of system 12 may also include several steps intended to detect collisions based on position errors in motor 30. In the illustrated embodiment these steps are shown being performed contemporaneously, and in some embodiments, simultaneously, with steps 132, 134 discussed above. By combining the two collision detection methodologies, the system 12 and method described herein increases the reliability of collision detection through system redundancy. It should be understood, however, that embodiments of system 12 and methods for detecting collisions during operation of system 12 could detect collisions using only one of load cells 40 or position error in motor 30.

As noted hereinabove, the inventors have determined that motor position error provides a quicker and more effective indicator of collision sensing than increased current draws by motor 30 used in conventional linear transfer systems. When used as an alternative to, or in addition to, detection of collisions using load cells 40, detection of collision based on motor position error has the further advantage of allowing detection of collisions involving components of carriage 28 and robot 10 where load cells 40 are not present during movement of carriage 28 and robot 10 along linear bearing 26 and axis 22.

As discussed hereinabove, during the programming mode the user may establish a motor position error threshold corresponding to collision sensitivity (the amount of force generated in any collision that is required to indicate a collision). The method for detecting collision resulting from movement of linear transfer system 12 during the operating mode may include the step 140 of determining the actual position of motor 30 (through, e.g., outputs from an encoder or other position sensor in motor 30) and the difference between the actual position of motor 30 and a commanded position of motor 30 (i.e., the motor position error). The method may then proceed to step 142 in which the motor position error is compared against the motor position error threshold. Step 142 may be performed by drive 70 of motor control circuit 42. If the motor position error meets a predetermined condition relative to the motor position error threshold (e.g., is greater than the motor position error threshold), the method may again continue with the step 136 of generating a control signal from drive 70 to motor 30 that is configured to inhibit further movement of carriage 28 along linear bearing 26 and axis 22 in the axial direction in which carriage 28 was moving. The control signal may further be configured to cause movement of carriage 28 along linear bearing 26 and axis 22 in an axial direction opposite to the axial direction in which carriage 28 was moving. The control signal may again, therefore, cause motor 30 to terminate delivery of any motive force or may cause motor 30 generate a motive force causing carriage 28 and robot 10 to move in the opposite axial direction. Drive 70 may also transmit a signal to controller 76 to alert controller 76 to the collision and thereby allow controller 76 to generate corresponding control signals to terminate movement of robot 10. Finally, in step 138, controller 77 may again transmit an indication of a collision to a user through, e.g., interface 74 or another audio, visual or haptic feedback system. A user of robot 10 and system 12 may be required to perform certain actions before movement can resume.

A linear transfer system 12 for a collaborative robot 10 in accordance with the present teachings is advantageous relative to conventional linear transfer systems. In certain embodiments, the linear transfer system 12 enables an operator to intuitively program movements of the linear transfer system 12 in a manner similar to programming a collaborative robot, but with assistance from a motor 30 of the linear transfer system 12. In other embodiments, the linear transfer system 12 is able to detect collisions resulting from movement of the linear transfer system 12 while also allowing an operator to adjust the sensitivity of the collision sensing system and achieving greater accuracy in collision sensing. In other embodiments, the linear transfer system 12 is able to accomplish both intuitive programming of movement of the system and improved collision sensing using the same operative components.

While the invention has been shown and described with reference to one or more particular embodiments thereof, it will be understood by those of skill in the art that various changes and modifications can be made without departing from the spirit and scope of the invention.

1. A linear transfer system for a collaborative robot, comprising:
a linear bearing extending along a linear axis;
a carriage supported on the linear bearing for movement along the linear axis, the carriage configured to support a collaborative robot;
a motor configured to generate a motive force causing movement of the carriage along the linear axis;
a first load cell supported on the carriage proximate a first axial end of the carriage; and,
a motor control circuit configured to
receive a first input signal indicative of a first force applied to the first load cell; and,
generate a first control signal for the motor configured to cause a first movement of the carriage along the linear axis, the first movement corresponding to the first force applied to the first load cell.

2. The linear transfer system of claim 1 wherein the motor control circuit is further configured to store in a memory a first instruction for generating the first control signal.

3. The linear transfer system of claim 1 wherein a speed for the first movement corresponds to an amount of the first force.

4. The linear transfer system of claim 1 wherein the motor control circuit is further configured to.
receive a second input signal indicative of a second force applied to the first load cell; and,
generate a second control signal to the motor configured to cause a second movement of the carriage along the linear axis, the second movement corresponding to the second force applied to the first load cell.

5. The linear transfer system of claim 4 wherein the motor control circuit is further configured to:
store in a memory a first instruction for generating the first control signal; and,
store in the memory a second instruction for generating the second control signal.

6. The linear transfer system of claim 1, further comprising a second load cell supported on the carriage proximate one of the first axial end of the carriage and a second axial end of the carriage and wherein the motor control circuit is further configured to:
receive a second input signal indicative of a second force applied to the second load cell; and,
generate a second control signal to the motor configured to cause a second movement of the carriage along the linear axis, the second movement corresponding to the second force applied to the second load cell.

7. The linear transfer system of claim 6 wherein the motor control circuit is further configured to:
store in a memory a first instruction for generating the first control signal; and,
store in the memory a second instruction for generating the second control signal.

8. The linear transfer system of claim 1, further comprising a second load cell supported on the carriage proximate one of the first axial end of the carriage and a second axial end of the carriage and wherein the motor control circuit is further configured to:
receive a second input signal indicative of a second force applied to the second load cell;
average the first force and the second force; and,
generate the first control signal responsive to the average of the first force and the second force, wherein the first movement corresponds to the average of the first force applied to the first load cell and the second force applied to the second load cell.

9. The linear transfer system of claim 1 wherein the motor control circuit is further configured to:
receive a second input signal indicative of a second force applied to the first load cell during movement of the carriage along the linear axis in a first axial direction;
compare the first force to a predetermined threshold force; and,
generate, a second control signal to the motor configured to inhibit further movement of the carriage along the linear axis in the first axial direction if the second force meets a predetermined condition relative to the predetermined threshold force.

10. The linear transfer system of claim 9, further comprising a second load cell supported on the carriage proximate one of the first axial end of the carriage and a second axial end of the carriage and wherein the motor control circuit is further configured to:
receive a third input signal indicative of a third force applied to the second load cell during movement of the carriage along the linear axis in the first axial direction;
average the second force and the third force; and,
generate the second control signal if the average of the second force and the third force meets a predetermined condition relative to the predetermined threshold force.

11. A linear transfer system for a collaborative robot, comprising:
a linear bearing extending along a linear axis;
a carriage supported on the linear bearing for movement along the linear axis, the carriage configured to support a collaborative robot;
a motor configured to generate a motive force causing movement of the carriage along the linear axis;
a first load cell supported on the carriage proximate a first axial end of the carriage; and,
a motor control circuit configured to
receive a first input signal indicative of a first force applied to the first load cell during movement of the carriage along the linear axis in a first axial direction;
compare the first force to a predetermined threshold force; and,
generate, a first control signal to the motor configured to inhibit further movement of the carriage along the linear axis in the first axial direction if the first force meets a predetermined condition relative to the predetermined threshold force.

12. The linear transfer system of claim 11, further comprising a second load cell supported on the carriage proximate one of the first axial end of the carriage and a second axial end of the carriage and wherein the motor control circuit is further configured to:
receive a second input signal indicative of a second force applied to the second load cell during movement of the carriage along the linear axis in the first axial direction;
average the first force and the second force; and,
generate the first control signal if the average of the first force and the second force meets a predetermined condition relative to the predetermined threshold force.

13. The linear transfer system of claim 11 wherein the first control signal is further configured to cause movement of the carriage along the linear axis in a second axial direction, opposite the first axial direction.

14. A linear transfer system for a collaborative robot, comprising:
a linear bearing extending along a linear axis;
a carriage supported on the linear bearing for movement along the linear axis, the carriage configured to support a collaborative robot;
a motor configured to generate a motive force causing movement of the carriage along the linear axis; and,
a motor control circuit configured to
establish a motor position error threshold;
compare a difference between an actual motor position and a commanded motor position to the motor position error threshold; and,
generate a first control signal to the motor configured to inhibit further movement of the carriage along the linear axis in a first axial direction if the difference between the measured motor position and the commanded motor position meets a predetermined condition relative to the motor position error threshold.

15. The linear transfer system of claim 14 wherein the first control signal is further configured to cause movement of the carriage along the linear axis in a second axial direction, opposite the first axial direction.

16. The linear transfer system of claim 14, further comprising a first load cell supported on the carriage proximate a first axial end of the carriage and wherein the motor control circuit is further configured to:
receive a first input signal indicative of a first force applied to the first load cell during movement of the carriage along the linear axis in the first axial direction;
compare the first force to a predetermined threshold force; and,
generate, a second control signal to the motor configured to inhibit further movement of the carriage along the linear axis in the first axial direction if the second force meets a predetermined condition relative to the predetermined threshold force.

17. The linear transfer system of claim 14, wherein the motor control circuit is further configured to:
control the motor to cause movement of the carriage along the entire length of the linear axis;
determine an amount of current required by the motor at each of a plurality of different points as the carriage moves along the length of the linear axis;
average the amounts of current required by the motor at each of the plurality of different points to obtain an average current;
establish a maximum current level for the motor responsive to the average current.

18. The linear transfer system of claim 14 wherein the motor control circuit is further configured, in establishing the motor position error threshold, to:
receive a user input through a user interface and;
determine the motor position error threshold responsive to the user input.
